(19) United States
(12) Patent Application Publication
(10) Pub. No.: US 2026/0196712 A1
(43) Pub. Date: Jul. 9, 2026

(54) ELECTRONIC DEVICE

(71) Applicant: PEGATRON CORPORATION, TAIPEI CITY (TW)

(72) Inventors: Hung-Ming Yu, Taipei City (TW); I-Shu Lee, Taipei City (TW); Chao-Hsu Wu, Taipei City (TW); Chi-Yin Fang, Taipei City (TW); Hau Yuen Tan, Taipei City (TW)

(73) Assignee: PEGATRON CORPORATION, TAIPEI CITY (TW)

(21) Appl. No.: 19/440,676

(22) Filed: Jan. 6, 2026

(30) Foreign Application Priority Data
Jan. 8, 2025 (TW) 114100737

(51) Int. Cl. H01Q 1/27; H01Q 1/50

(52) U.S. Cl. CPC H01Q 1/273; H01Q 1/50

(57) ABSTRACT

An electronic device including a casing, a base and an antenna module. The base is located in the casing and has a first side, a second side, and a top side. The antenna module is located in the casing. A flexible printed circuit of the antenna module is disposed on the base and includes a first surface corresponding to the first side and a second surface corresponding to the top side. An antenna pattern of the antenna module has a feed portion adjacent to the first surface. The antenna pattern extends from the feed portion to above a second ground plane and a third ground plane of the second surface. There is a gap between a first section of the antenna pattern close to the feed portion and a first ground plane of the first surface to form a U-shaped ground plane.

### CROSS-REFERENCE TO RELATED APPLICATION

This application claims the priority benefit of Taiwan application serial no. 114100737, filed on January 8, 2025. The entirety of the above-mentioned patent application is hereby incorporated by reference herein and made a part of this specification.

### BACKGROUND

### Technical Field

The disclosure relates to an electronic device, and more particularly to an electronic device including an antenna module.

### Description of Related Art

In recent years, under the circumstance that various electronic devices are capable of performing wireless communication, various small antennas built into electronic devices have been developed. For example, in the case of being built into small wireless earphones, the antenna size becomes very small and is easily affected by the surrounding environment, resulting in degraded antenna performance.

### SUMMARY

The disclosure provides an electronic device allowing a three-dimensional antenna to be disposed in a limited space and having good antenna efficiency.

An electronic device of the disclosure includes a casing, a base, and an antenna module. The base is located in the casing and has a first side and a second side opposite to each other and a top side located between the first side and the second side. The antenna module is located in the casing and includes a flexible printed circuit and an antenna pattern. The flexible printed circuit is disposed on the base and includes a first surface corresponding to the first side and a second surface corresponding to the top side. The first surface is provided with a first ground plane, and the second surface is provided with a second ground plane and a third ground plane. The antenna pattern has a feed portion adjacent to the first surface. The antenna pattern extends from the feed portion to above the second ground plane and the third ground plane. A gap is provided between a first section of the antenna pattern close to the feed portion and the first ground plane to form a U-shaped ground plane.

In the embodiment of the disclosure, the first ground plane may be a recessed portion. The first section may be located in the recessed portion. Two opposite sides of the first sections may have an identical spacing distance from the recessed portion.

In an embodiment of the disclosure, the spacing distance may be in a range of 0.1 millimeters to 0.3 millimeters.

In an embodiment of the disclosure, the antenna module may further include a first capacitor located in the gap and connected to one of the two opposite sides of the first section to form a parallel connection with the first section.

In an embodiment of the disclosure, the antenna module may further include a second capacitor located in the gap and connected to the feed portion and an end of the first section to form a series connection with the first section.

In an embodiment of the disclosure, the antenna module may further include a pad disposed on the second surface.

In an embodiment of the disclosure, the antenna pattern may further include a second section connected to the first section. The second section may be disposed on the pad to be spaced apart from the second ground plane and the third ground plane.

In an embodiment of the disclosure, the second section may include a first segment, a second segment, and a third segment sequentially connected, and the first segment, the second segment, and the third segment may form a plurality of bends.

In an embodiment of the disclosure, the pad may have a thickness, and the thickness may be in a range of 0.5 millimeters to 0.7 millimeters.

In an embodiment of the disclosure, the electronic device may further include a connecting structure and an ear pad, and the connecting structure may be located between the ear pad and the casing.

Based on the above, in the electronic device of the disclosure, the flexible printed circuit is disposed on the base. The flexible printed circuit is provided with the first ground plane corresponding to the first side of the base, and the flexible printed circuit is provided with the second and the third ground planes corresponding to the top side of the base. One end of the antenna pattern extends into the first ground plane to form a U-shaped ground plane, and the other end of the antenna pattern extends to above the second ground plane and the third ground plane. The three-dimensional space attached to the base is effectively utilized to generate a BT antenna frequency band.

To make the features and advantages of the disclosure more comprehensible, several embodiments accompanied with drawings are described in detail as follows.

### BRIEF DESCRIPTION OF THE DRAWINGS

FIG. 1 is a perspective schematic diagram of an electronic device according to an embodiment of the disclosure;

FIG. 2A is a perspective schematic diagram of partial components of the electronic device of FIG. 1;

FIG. 2B is a perspective schematic diagram of the electronic device of FIG. 1;

FIG. 3 is a partially enlarged schematic diagram of the electronic device of FIG. 2A;

FIG. 4 is a schematic diagram of an antenna structure of the electronic device of FIG. 2A;

FIG. 5 is a schematic diagram showing the electronic device of an embodiment of the disclosure applied to a human ear;

FIG. 6 is a frequency-VSWR graph showing the antenna structure of the electronic device of FIG. 5 with and without matching circuits;

FIG. 7 is a frequency-antenna efficiency graph showing a comparison between a conventional antenna structure and the antenna structure of FIG. 5; and

FIGS. 8A to 8C are radiation pattern diagrams of the antenna structure of the electronic device of FIG. 5.

### DESCRIPTION OF THE EMBODIMENTS

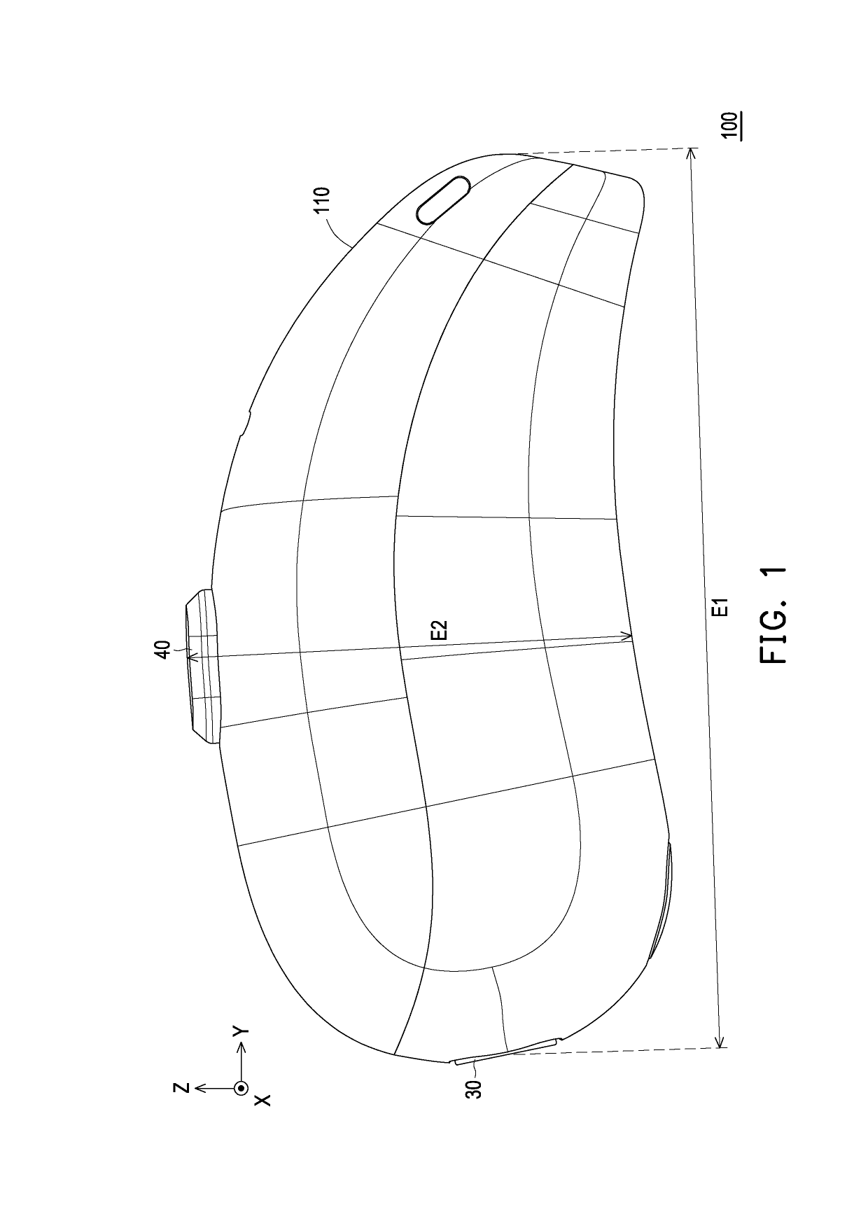

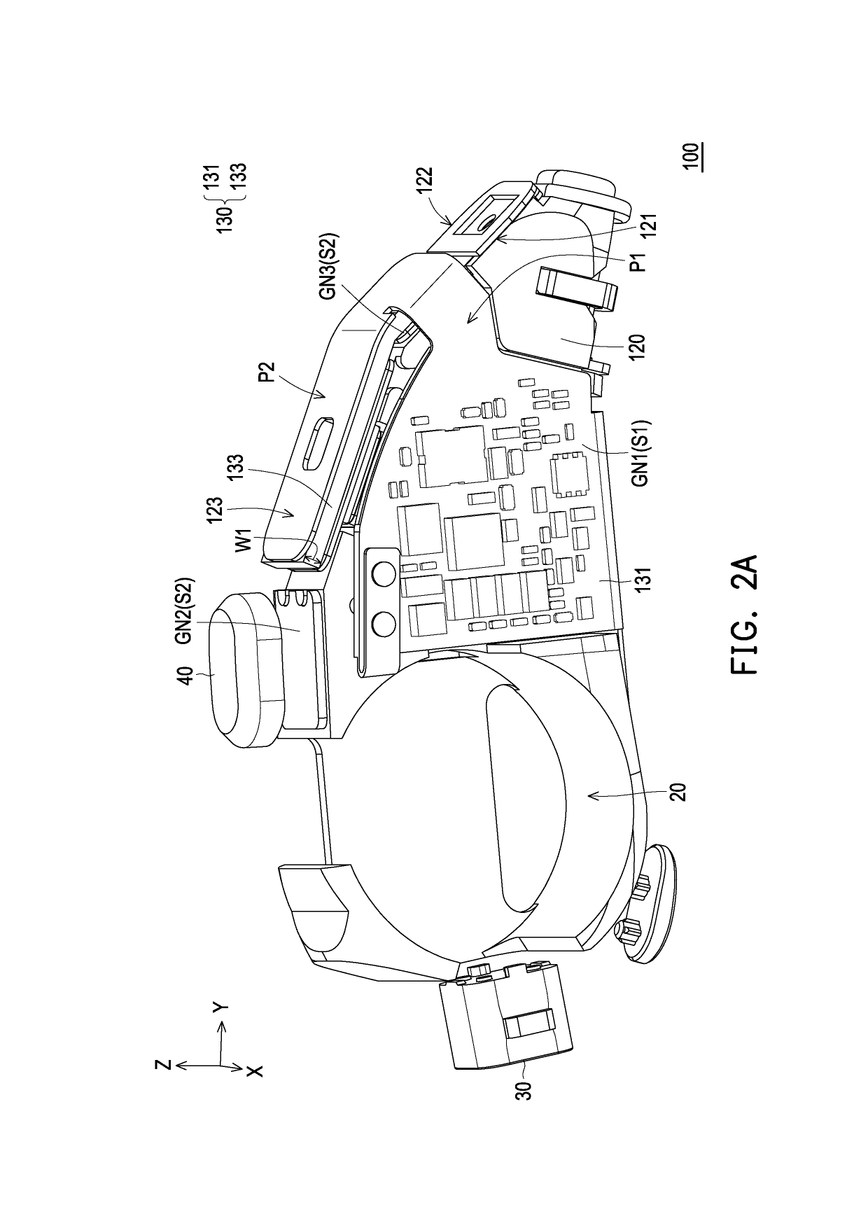

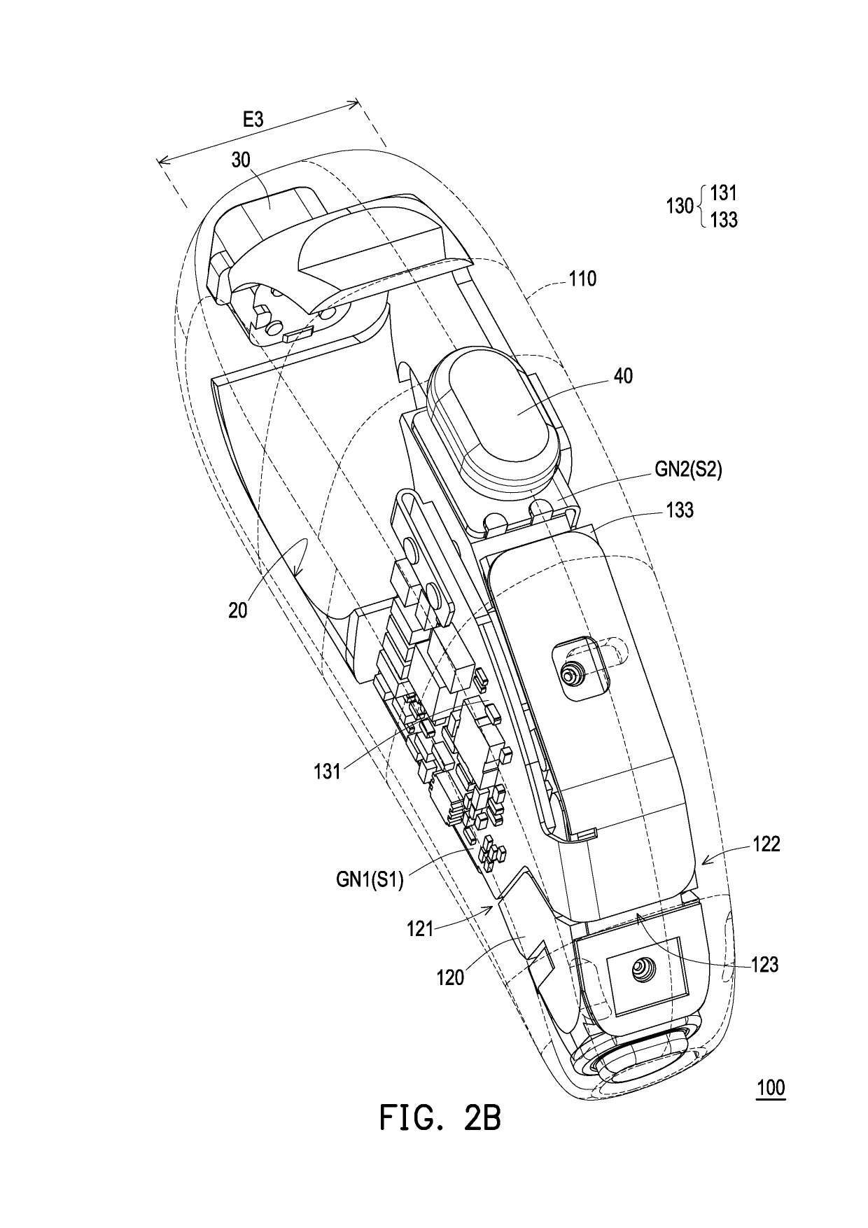

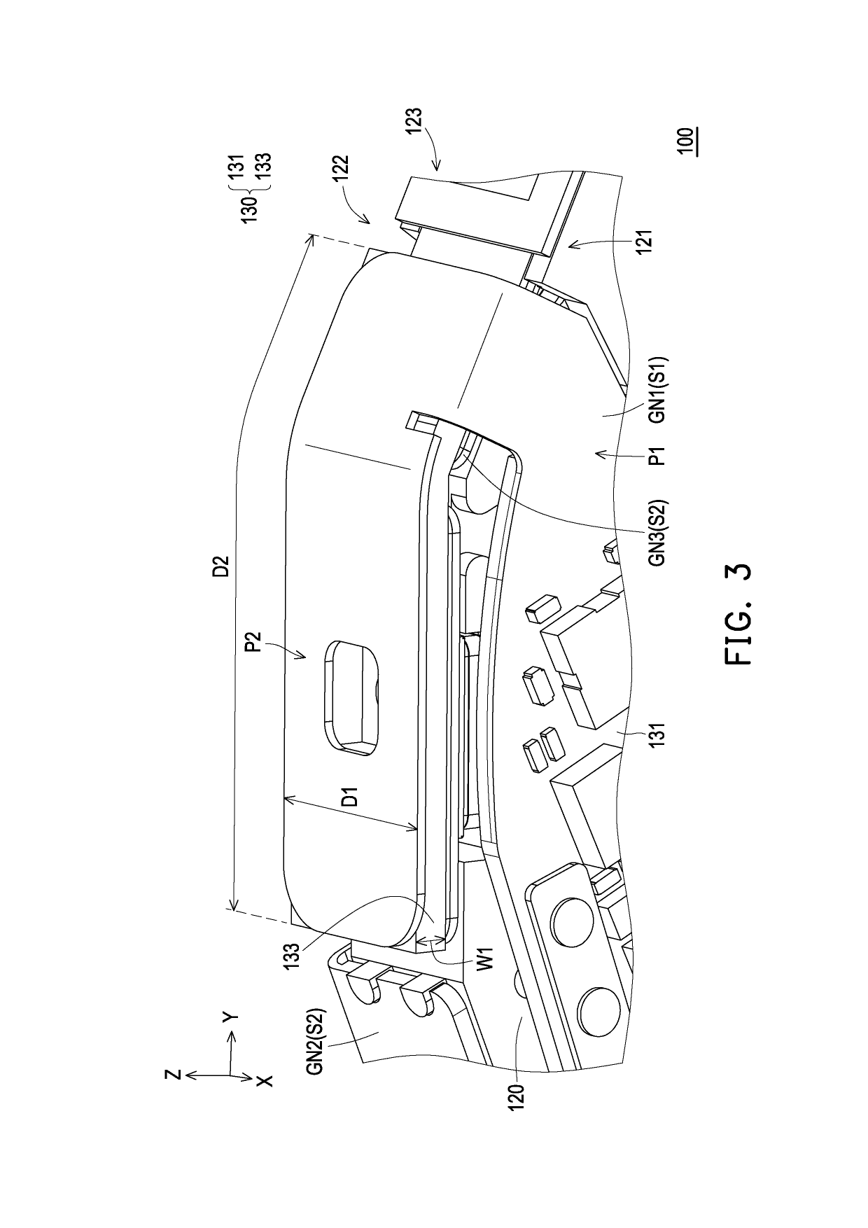

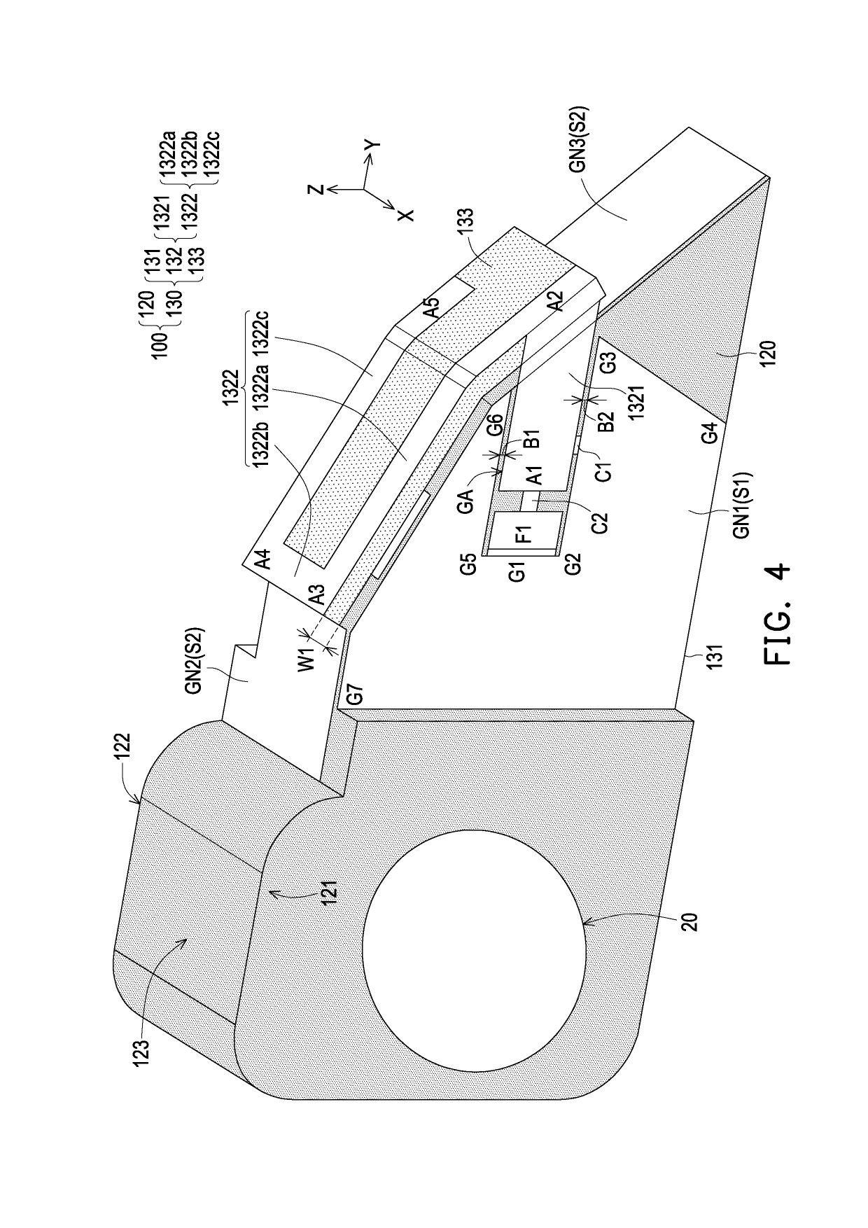

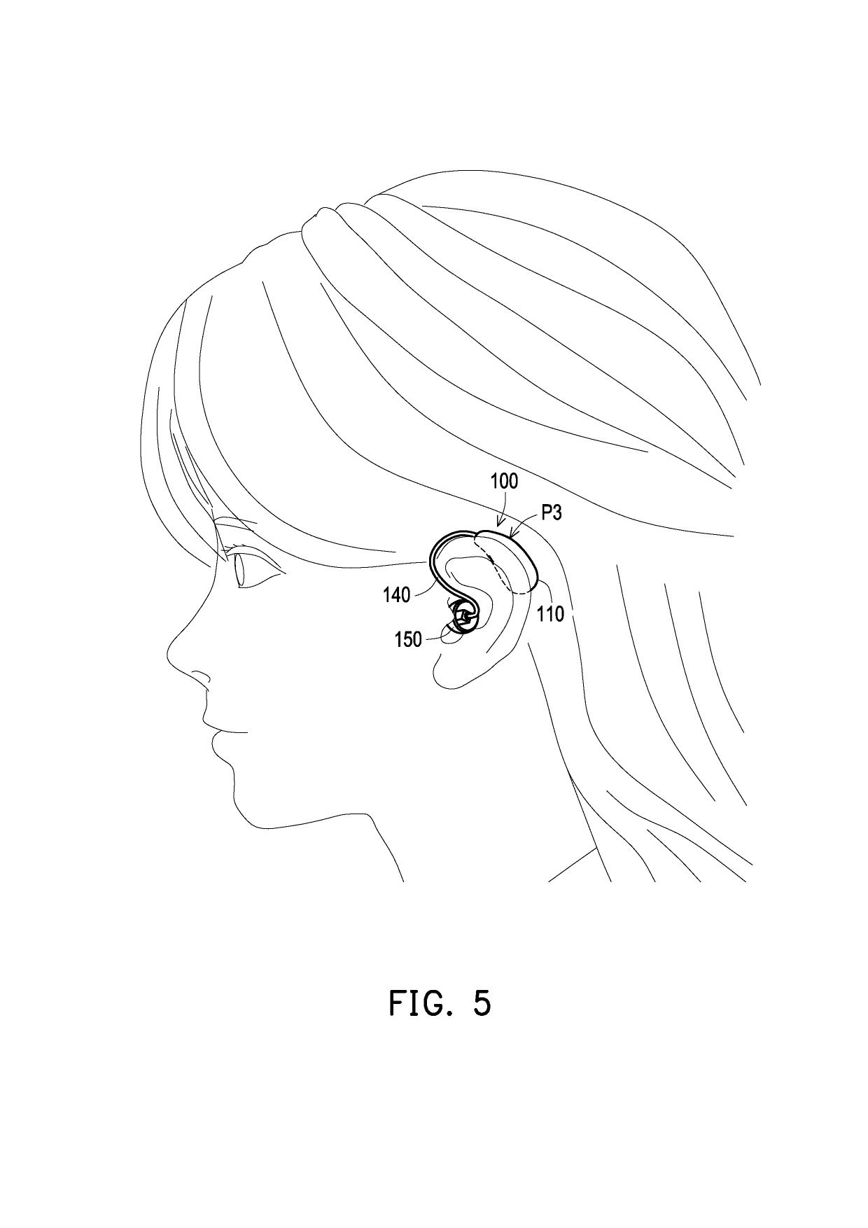

FIG. 1 is a perspective schematic diagram of an electronic device of an embodiment of the disclosure. FIG. 2A is a perspective schematic diagram of partial components of the electronic device of FIG. 1. FIG. 2B is a perspective schematic diagram of the electronic device of FIG. 1. FIG. 3 is a partially enlarged schematic diagram of the electronic device of FIG. 2A. FIG. 4 is a schematic diagram of an antenna structure of the electronic device of FIG. 2A. FIG. 5 is a schematic diagram showing the electronic device of an embodiment of the disclosure applied to a human ear. This embodiment also provides a rectangular coordinate system X-Y-Z for component identification.

Please refer to FIGS. 1 to 5. An electronic device 100 of this embodiment includes a casing 110, a base 120, and an antenna module 130. The base 120 and the antenna module 130 are located in the casing 110. The antenna module 130 includes a flexible printed circuit (FPC) 131 and an antenna pattern 132 (FIG. 4). It should be noted that FIGS. 2A, 2B, and 3 omit the illustration of the antenna pattern on the flexible printed circuit. The layout of the antenna pattern will be described in FIG. 4.

Please refer to FIG. 2B. In this embodiment, the base 120 has a first side 121 and a second side 122 opposite to each other, and a top side 123 located between the first side 121 and the second side 122. The flexible printed circuit 131 is disposed on the base 120 and includes a first surface S1 corresponding to the first side 121 and a second surface S2 corresponding to the top side 123.

Please refer to FIGS. 1 and 2B. A length E1 of the casing 110 is about 28.9 millimeters. A length E2 is about 14.5 millimeters. A length E3 is about 8.3 millimeters. However, the disclosure is not limited thereto.

In this embodiment, the flexible printed circuit 131 is formed in a three-dimensional one-piece structure and is attached to the base 120 to effectively utilize the narrow space between the base 120 and the casing 110. Here, the casing 110 is a plastic casing, and the base 120 is a plastic structure. However, the disclosure is not limited thereto.

In this embodiment, a BT chip circuit is provided on the first surface S1 of the flexible printed circuit 131 to perform wireless communication through Bluetooth, and to be paired with other electronic devices to transmit or receive data for mutual data transmission capability. However, the disclosure is not limited thereto.

In this embodiment, the electronic device 100 is a Behind the Ear (BTE) hearing aid. However, the disclosure is not limited thereto. In other embodiments, the electronic device 100 may also be an earphone or another small wearable device. In this embodiment, the electronic device 100 further includes a battery compartment 20, a charging connector 30, a button 40, a connecting structure 140 (FIG. 5), and an ear pad 150 (FIG. 5). In FIG. 5, the connecting structure 140 is located between the ear pad 150 and the casing 110. The ear pad 150 is aligned with the ear canal to output audio. However, the disclosure is not limited thereto. It should be noted that, in FIGS. 1 to 4, some irrelevant structures are omitted to facilitate display and identification of the components to be described. The operation and implementation manner of the BTE hearing aid can be sufficiently taught, suggested, and described by the ordinary knowledge in the technical field to which it pertains, and thus will not be repeated herein.

In this embodiment, the first surface S1 of the flexible printed circuit 131 corresponding to the first side 121 is provided with a first ground plane GN1. The second surface S2 of the flexible printed circuit 131 corresponding to the top side 123 is provided with a second ground plane GN2 and a third ground plane GN3.

Please refer to FIG. 4. In this embodiment, the antenna pattern 132 has a feed portion F1 adjacent to the first surface S1. The antenna pattern 132 extends from the feed portion F1 to above the second ground plane GN2 and the third ground plane GN3. In addition, for clarity, FIG. 4 schematically and simply illustrates the base and the antenna module. The antenna pattern 132 shown in FIG. 4 can be integrated into the flexible printed circuit 131 shown in FIGS. 2A, 2B, and 3.

Specifically, in this embodiment, the antenna pattern 132 includes a first section 1321 and a second section 1322 connected to each other. The second section 1322 includes a first segment 1322a, a second segment 1322b, and a third segment 1322c sequentially connected. The first segment 1322a, the second segment 1322b, and the third segment 1322c form a plurality of bends to effectively utilize the space.

In this embodiment, the extending directions of the first segment 1322a and the third segment 1322c are the same and are different from the extending direction of the second segment 1322b. Specifically, the antenna pattern 132 is, for example, in a Z-shape or an S-shape. However, the disclosure is not limited thereto. In one embodiment, the first section 1321 of the antenna pattern 132 is correspondingly disposed at a position P1 shown in FIG. 2A, and the second section 1322 of the antenna pattern 132 extends from the position P1 to a position P2 shown in FIG. 2A.

As shown at the position P2 in FIG. 3, a width D1 thereof is about 3.7 millimeters, and a width D2 thereof is about 11.4 millimeters. Accordingly, the plane referred to by the position P2 is approximately 11.4 mm × 3.7 mm and is used as an antenna pattern layout area. However, the disclosure is not limited thereto.

Accordingly, in FIG. 5, the electronic device 100 can be attached and fixed to the ear for user use. Most of the antenna pattern 132 of the antenna module 130 corresponds to an upper side P3 of the casing 110 and lies flat above the ear and therefore it is less likely to be affected by the proximity of human attachment thus to obtain better omnidirectional radiation pattern performance.

Please refer to FIG. 4. In this embodiment, a gap GA is provided between the first section 1321 of the antenna pattern 132 close to the feed portion F1 and the first ground plane GN1 to form a U-shaped ground plane. Specifically, in the antenna module 130, the feed portion F1 transmits a signal to the antenna pattern 132 for electrical connection to a signal positive terminal. The ground terminal is surrounded by a U-shaped ground plane formed by a point G6, a point G5, a point G1, a point G2, and a point G3 on the first ground plane GN1 for electrical connection to a signal negative terminal connected to a system ground plane.

In this embodiment, the first ground plane GN1 has a recessed portion, and the first section 1321 is located in the recessed portion. In the Z direction, two opposite sides of the first section 1321 respectively have identical spacing distances B1 and B2 from the recessed portion. The spacing distances B1 and B2 are between 0.1 millimeters and 0.3 millimeters. In one embodiment, the spacing distances B1 and B2 are, for example, 0.2 millimeters, but the disclosure is not limited thereto.

In this embodiment, the matching circuit (with a ground capacitance value) can be appropriately added to adjust the antenna resonance frequency and bandwidth to be properly tuned. For example, the antenna module 130 further includes a first capacitor C1 and a second capacitor C2. The first capacitor C1 is located in the gap GA and is connected to one of the two opposite sides of the first section 1321 (for example, a side away from a pad 133, but not limited thereto) to form a parallel connection with the first section 1321. The second capacitor C2 is located in the gap GA and is connected to the feed portion F1 and an end of the first section 1321 to form a series connection with the first section 1321.

In this embodiment, the second section 1322 of the antenna pattern 132 is disposed on the pad 133 to be spaced apart from the second ground plane GN2 and the third ground plane GN3. The pad 133 has a thickness W1. The thickness W1 is between 0.5 millimeters and 0.7 millimeters. In one embodiment, the thickness W1 of the pad 133 is 0.6 millimeters, but the disclosure is not limited thereto. That is, the antenna pattern 132 is spaced apart from the second ground plane GN2 and the third ground plane GN3 by 0.6 millimeters. In general, conventional chip antenna designs all require an antenna clearance area in the height direction of the YZ plane (i.e., no metal is allowed). Accordingly, when the antenna is 0.6 millimeters away from the ground plane, the antenna efficiency deteriorates to -7.8 to -11.8 dBi. However, under the above configuration of the disclosure, the BT antenna efficiency can be improved to -6.2 to -7.8 dBi. In an extremely small antenna space of 12.5 mm × 3 mm, broadband and good antenna efficiency characteristics are provided.

Under the above configuration, the feed portion F1 is directly connected to a Z-shaped antenna pattern (that is, the antenna pattern 132) along the path of a point A1, a point A2, a point A3, a point A4, and a point A5. Between the path of the feed portion F1 and the point A1 and the U-shaped ground plane formed by the path of the point G6, the point G5, the point G1, the point G2, and the point G3 on the first ground plane GN1, identical spacing distances B1 and B2 are provided to form a BT antenna structure with a Z-shaped co-planar waveguide (CPW) feed. In an extremely small three-dimensional space, by increasing the matching circuit, the antenna resonance frequency and bandwidth can be properly tuned to meet the design requirements. That is, the point A1 of the Z-shaped antenna pattern is first grounded in parallel with the first capacitor C1, and then the second capacitor C2 is connected in series to the BT chip circuit end. The capacitance value range of the first capacitor C1 is 1.5 pF to 2 pF. In one embodiment, the capacitance value of the first capacitor C1 is, for example, 1.8 pF, but the disclosure is not limited thereto. The capacitance value range of the second capacitor C2 is 0.5 pF to 0.7 pF. In one embodiment, the capacitance value of the second capacitor C2 is, for example, 0.6 pF, but the disclosure is not limited thereto.

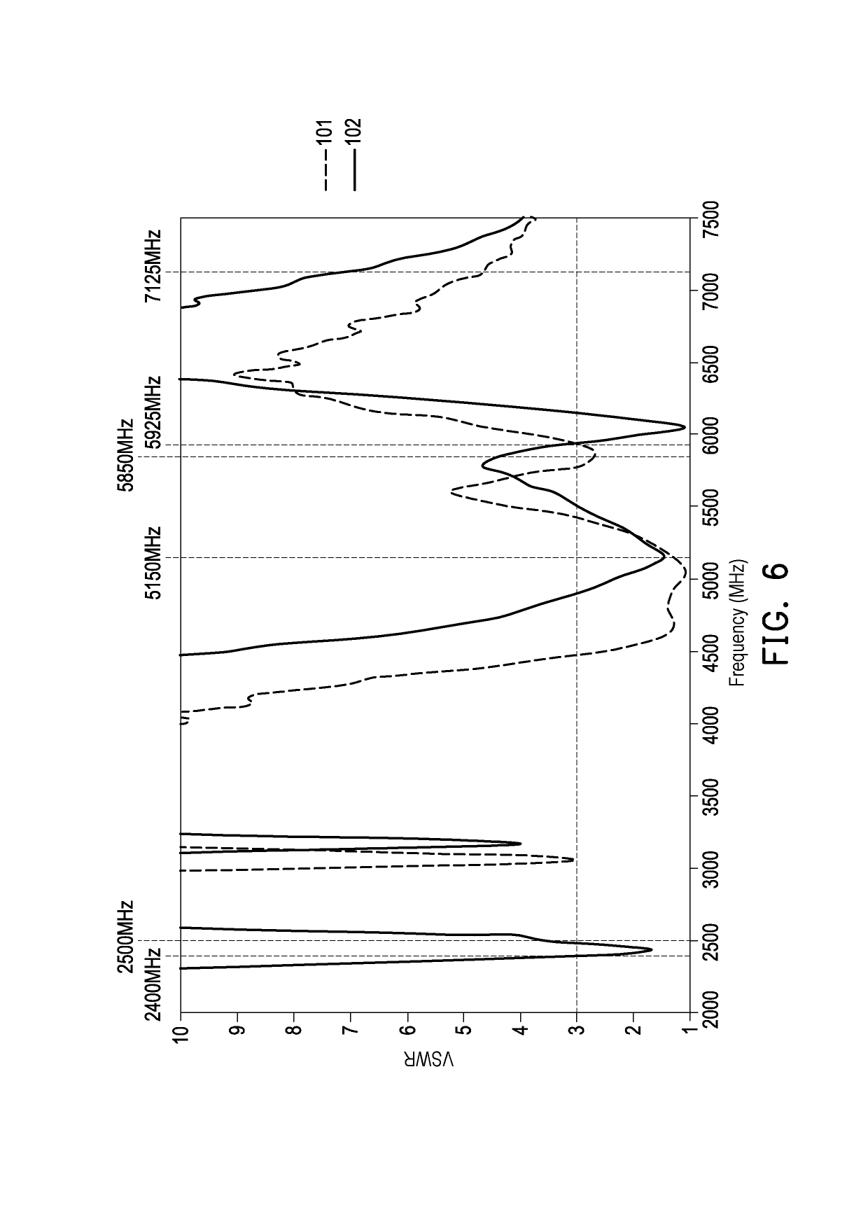

FIG. 6 is a frequency-VSWR graph of the antenna structure of the electronic device of FIG. 5 with and without matching circuits. Please refer to FIG. 6. A line segment 101 indicates the frequency-VSWR relationship of the antenna pattern 132, and a line segment 102 indicates the frequency-VSWR relationship of the antenna pattern 132 with the matching circuit. It can be seen that after adding the matching circuit, the Voltage Standing Wave Ratio (VSWR) can be below 3, thereby improving antenna characteristics.

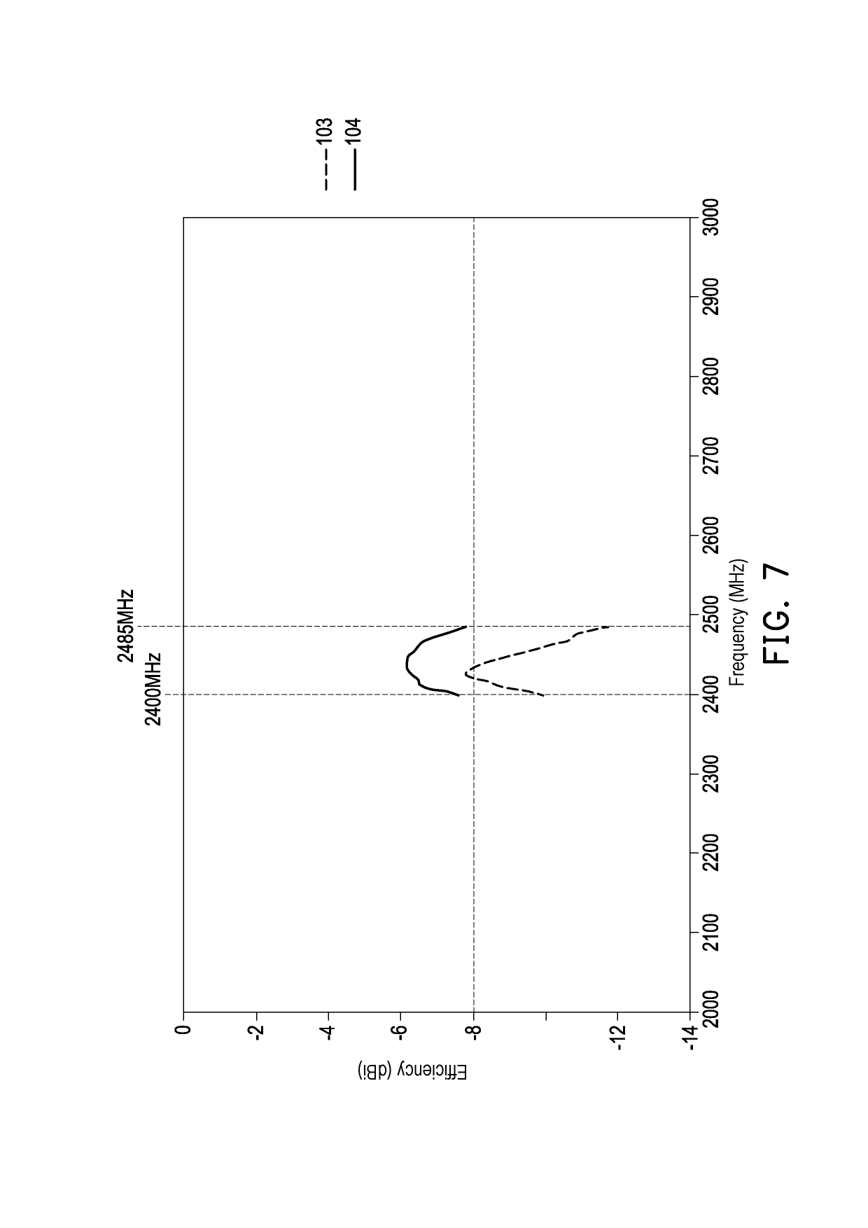

FIG. 7 is a frequency-antenna efficiency graph showing a comparison between a conventional antenna structure and the antenna structure of FIG. 5. Please refer to FIG. 7. A line segment 103 indicates the performance of a conventional chip antenna, and a line segment 104 indicates the performance of the antenna module 130 of this embodiment. Compared with the performance of the conventional chip antenna, the antenna efficiency of this embodiment can be improved by 1.5 dBi to 4 dBi. The antenna efficiency of the electronic device 100 of this embodiment in the BT frequency band (2400 MHz to 2485 MHz) is -6.2 dBi to -7.8 dBi. In an extremely small antenna space of 12.5 mm × 3 mm, broadband and good antenna efficiency characteristics are provided.

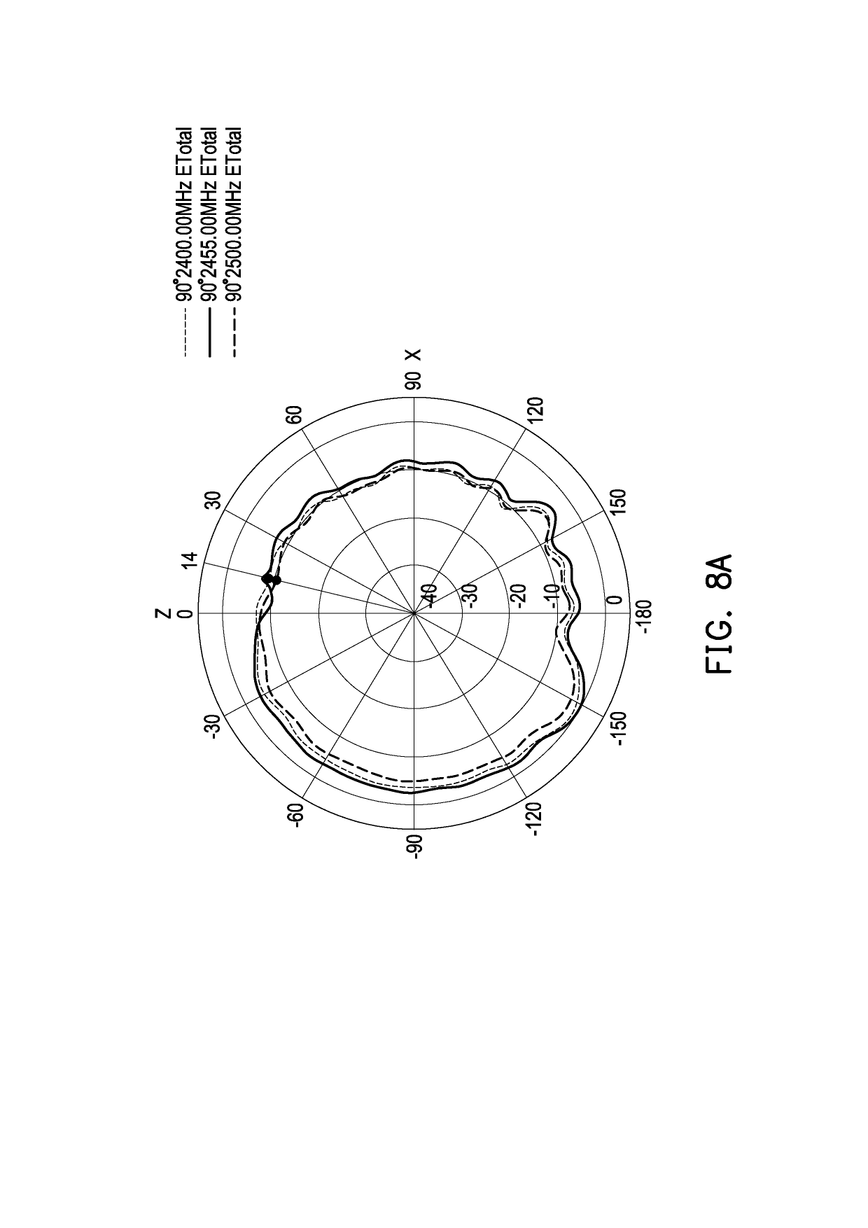

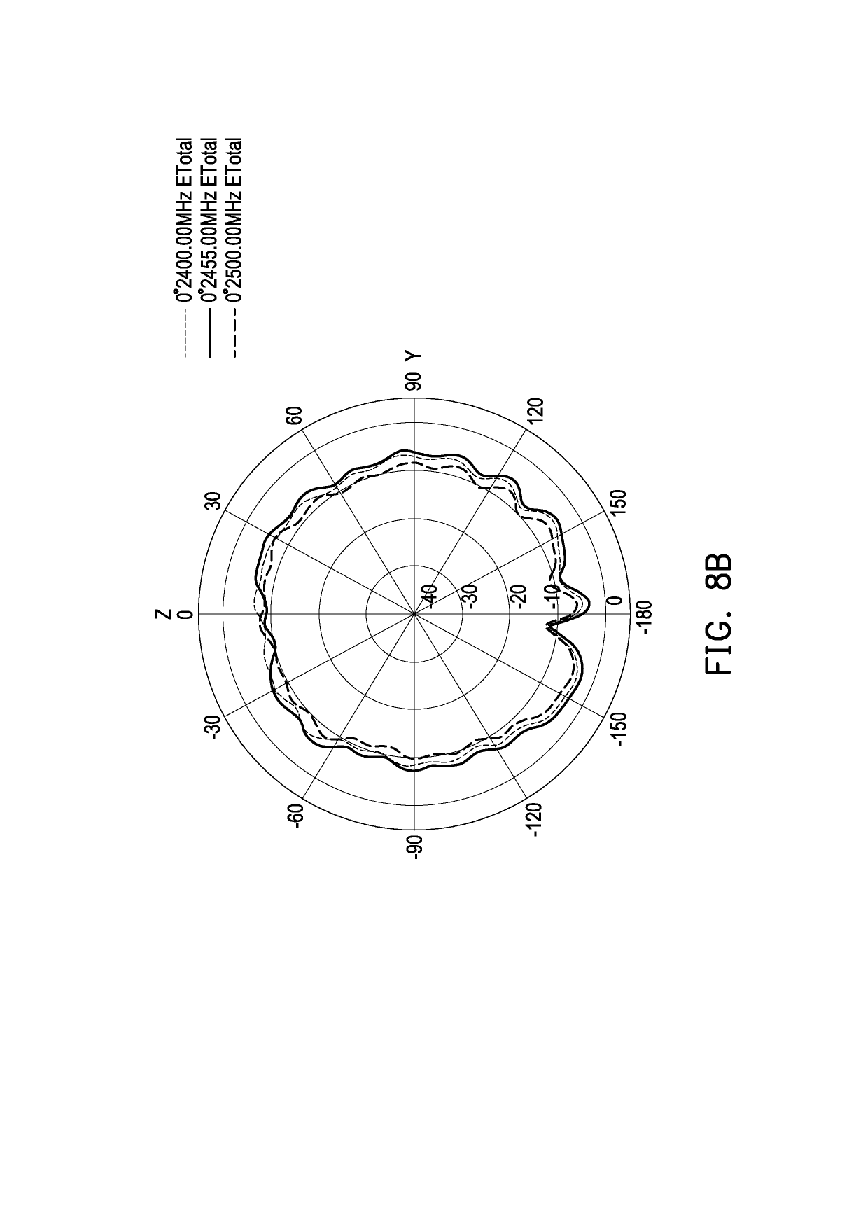

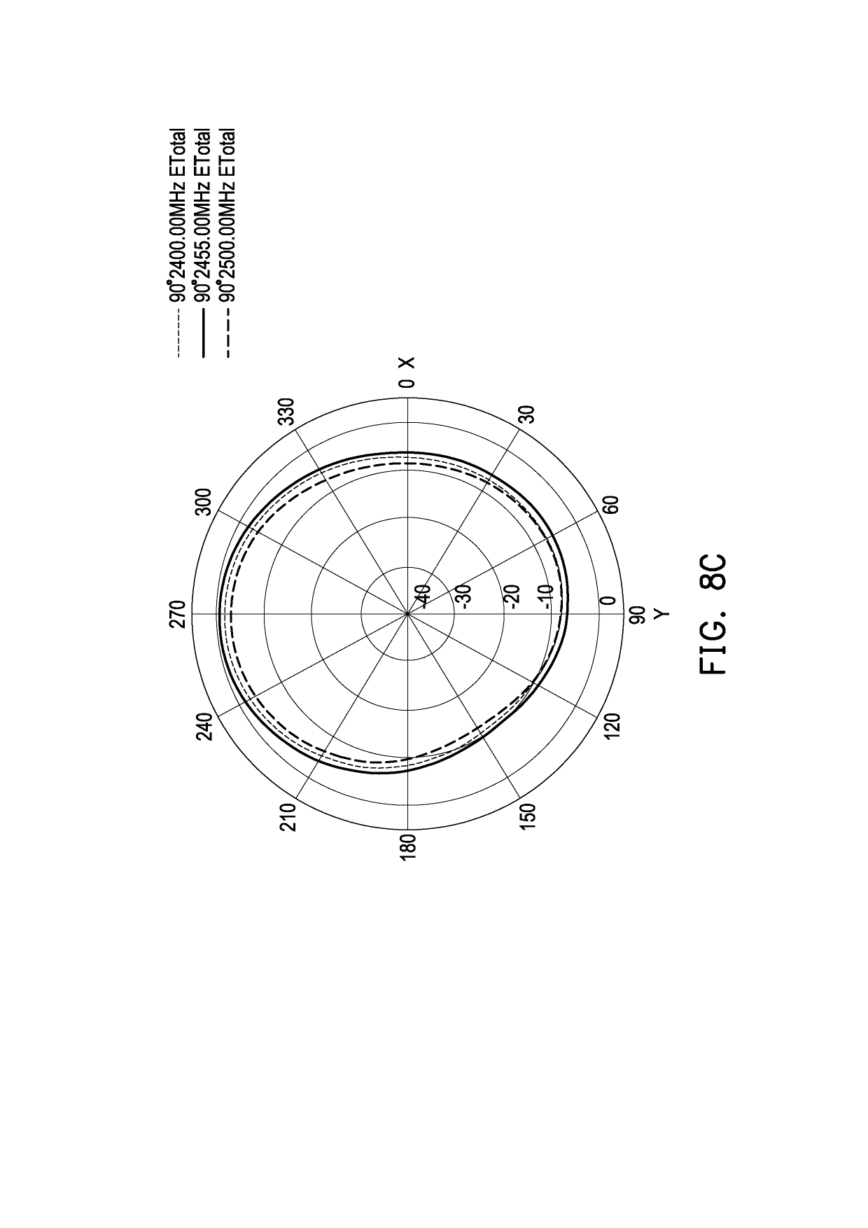

FIGS. 8A to 8C are radiation pattern diagrams of the antenna structure of the electronic device of FIG. 5. Please refer to FIGS. 8A to 8C. The electronic device 100 of this embodiment has an omnidirectional radiation pattern performance.

In summary, in the electronic device of the embodiment of the disclosure, a Z-shaped antenna pattern is integrated on a three-dimensional one-piece FPC and its surface area. Together with the first capacitor and the second capacitor matching circuit, and in combination with the coplanar waveguide feed and the U-shaped ground plane environment, the BT antenna can be supported to at least cover the 2400 to 2485 MHz frequency band, so as to achieve broadband and good antenna efficiency characteristics in an extremely small antenna space.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An electronic device, comprising:
a casing;
a base located in the casing and having a first side and a second side opposite to each other and a top side located between the first side and the second side; and
an antenna module located in the casing and including:
a flexible printed circuit disposed on the base and including a first surface corresponding to the first side and a second surface corresponding to the top side, wherein the first surface is provided with a first ground plane, and the second surface is provided with a second ground plane and a third ground plane; and
an antenna pattern having a feed portion adjacent to the first surface, wherein the antenna pattern extends from the feed portion to above the second ground plane and the third ground plane, and there is a gap between a first section of the antenna pattern close to the feed portion and the first ground plane to form a U-shaped ground plane.

2. The electronic device according to claim 1, wherein the first ground plane has a recessed portion, the first section is located in the recessed portion, and two opposite sides of the first section have an identical spacing distance from the recessed portion.

3. The electronic device according to claim 2, wherein the spacing distance is in a range of 0.1 millimeters to 0.3 millimeters.

4. The electronic device according to claim 2, wherein the antenna module further comprises a first capacitor located in the gap and connected to one of the two opposite sides of the first section to form a parallel connection with the first section.

5. The electronic device according to claim 4, wherein the antenna module further comprises a second capacitor located in the gap and connected to the feed portion and an end of the first section to form a series connection with the first section.

6. The electronic device according to claim 2, wherein the antenna module further comprises a pad disposed on the second surface.

7. The electronic device according to claim 6, wherein the antenna pattern further comprises a second section connected to the first section, and the second section is disposed on the pad to be spaced apart from the second ground plane and the third ground plane.

8. The electronic device according to claim 7, wherein the second section comprises a first segment, a second segment, and a third segment sequentially connected, and the first segment, the second segment, and the third segment form a plurality of bends.

9. The electronic device according to claim 6, wherein the pad has a thickness, and the thickness is in a range of 0.5 millimeters to 0.7 millimeters.

10. The electronic device according to claim 1, further comprising a connecting structure and an ear pad, wherein the connecting structure is located between the ear pad and the casing.
